(19) United States
(12) Patent Application Publication
(10) Pub. No.: US 2013/0142569 A1
(43) Pub. Date: Jun. 6, 2013

(54) ANTI-ROTATION CABLE RESTRAINT FOR CONNECTING FLEXIBLE DUCTS

(71) Applicants: MARK EDMUND KOLDER, TORRANCE, CA (US); MARK FEWELL, RIVERSIDE, CA (US)

(72) Inventors: MARK EDMUND KOLDER, TORRANCE, CA (US); MARK FEWELL, RIVERSIDE, CA (US)

(73) Assignee: HONEYWELL INTERNATIONAL INC., MORRISTOWN, NJ (US)

(21) Appl. No.: 13/310,430

(22) Filed: Dec. 2, 2011

(51) Int. Cl. F16B 7/04; B23P 11/00

(52) U.S. Cl. 403/343; 29/525.11

(57) ABSTRACT

An anti-rotation cam adapted to prevent rotation of a cable restraint is described. The anti-rotation cam includes a body having a through-hole adapted to be coupled to a fitting of the cable restraint, a first leg extending out from the body and adapted to prevent the cam from rotating in a clockwise direction, and a second leg extending out from the body and adapted to prevent the cam from rotating in a counter-clockwise direction.

### BACKGROUND AND SUMMARY OF THE INVENTION

The present invention generally relates to a way of connecting flexible ducts to each other. Such ducts may be connected by securing a set of cable restraints to a flange at an end of each duct. The ducts may be disconnected by decoupling the set of cable restraints from the flanges.

The cable restraints may typically include a metal shaft or wire rope that includes a fitting with wrench flats at the interior end and an external screw thread at the exterior end of the fitting. The interior wrench flats and exterior thread with nut may then be used to secure the cable restraint to each flange. The wrench flats refers to the flats on the surface of the flange facing the other duct, while the “exterior” nut refers to the nut on the surface of the flange facing away from the other duct. The interior wrench flats must be positioned such that the spacing between the two cables is maintained at an appropriate distance. The exterior nut must then be tightened while the interior wrench flats is prevented from rotating. When de-coupling the cables, the interior wrench flats must be prevented from rotating while the exterior nut is loosened.

A technician may typically complete the task of connecting or disconnecting the ducts using two hands and at least two tools (e.g., one hand to hold a wrench and secure the interior wrench flats and another hand to hold a wrench and tighten the exterior nut). In addition, the technician may need to measure the gap between the two duct flanges and/or use a “jig” or other such device to maintain the appropriate spacing between the duct flanges.

As can be seen, there is a need for a cable restraint that may be installed or removed with one hand and one tool, allowing easier access in confined spaces in which the ducts may be connected. In addition, there is a need for a cable restraint that automatically sets the proper gap between connected duct flanges without the need for any measurement, gage, and/or jig.

In one aspect of the present invention, an anti-rotation cam adapted to prevent rotation of a cable restraint includes a body having a through-hole adapted to be coupled to a fitting of the cable restraint, a first leg extending out from the body and adapted to prevent the cam from rotating in a clockwise direction, and a second leg extending out from the body and adapted to prevent the cam from rotating in a counter-clockwise direction.

In another aspect of the present invention, an anti-rotation cable restraint for connecting ducts includes a flexible cable, a first threaded end coupled to the cable along an axis of the cable, and a first anti-rotation cam coupled to the first threaded end perpendicular to the axis of the cable, the cam being adapted to prevent rotation of the cable and the threaded end when a nut is secured to the first threaded end.

In yet another aspect of the present invention, a method of coupling a first flexible duct with a first flange to a second flexible duct with a second flange using an anti-rotation cable restraint includes: aligning the cable restraint with a through-hole of the first flange, securing the cable restraint to the first flange using a first lock nut, aligning the cable restraint with a through-hole of the second flange, and securing the cable restraint to the second flange using a second lock nut.

These and other features, aspects and advantages of the present invention will become better understood with reference to the following drawings, description and claims.

### BRIEF DESCRIPTION OF THE DRAWINGS

FIG. 1 illustrates a perspective view of an anti-rotation cable restraint according to an exemplary embodiment of the present invention;

FIG. 2 illustrates a side view of the cable restraint of FIG. 1, specifically showing the anti-rotation cam;

FIG. 3 illustrates a perspective view of the cable restraint of FIG. 1 during use;

FIG. 4 illustrates a section view of the cable restraint of FIG. 1 during use, specifically highlighting the gap maintained by the cable restraint; and

FIG. 5 illustrates a conceptual process 500 used in some embodiments when connecting or disconnecting a pair of ducts.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. Broadly, embodiments of the present invention generally provide a way to connect duct segments using one or more cable restraints. The cable restraints of the present invention may be configured to be anti-rotation such that the restraint does not rotate when coupled to a duct flange. In this manner, the cable restraints may be attached to (or detached from) the duct flange using a single tool (and/or a single hand or other manipulation apparatus).

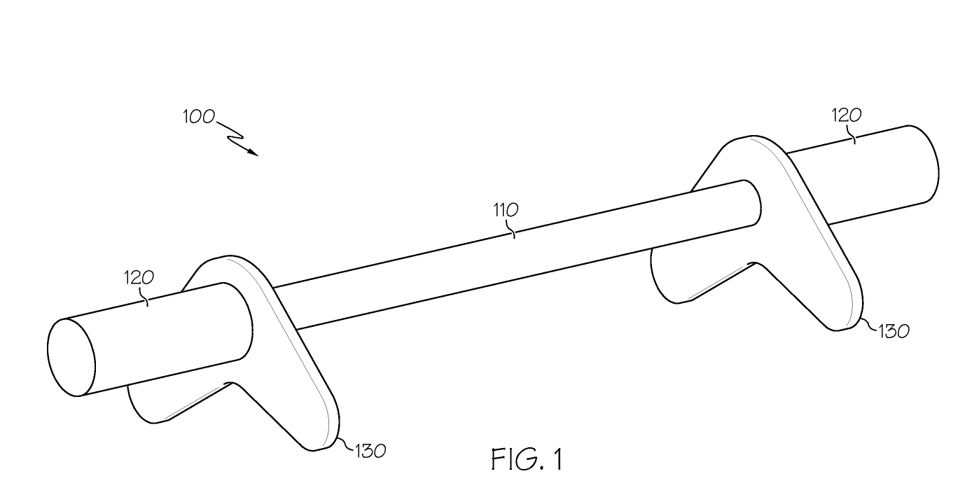

FIG. 1 illustrates a perspective view of an anti-rotation cable restraint according to an exemplary embodiment of the present invention. Specifically, this figure shows the various components of the cable restraint 100, which may include a cable 110, two threaded ends (or “fittings”) 120, and two anti-rotation cams 130. The cable 110 may be an appropriate length of flexible wire rope of an appropriate diameter for the duct segments to be connected. The cable extends through threaded end 120 and may provide a male component for coupling with a threaded end fitting. The threaded ends may be cylindrical pieces of metal of an appropriate diameter.

As shown in FIG. 1, the anti-rotation cams 130 may be V-shaped pieces of metal (i.e., a triangular shape having two legs) that may be coupled to the threaded ends such that the cams rotate when the threaded end rotates. The cams 130 may be fashioned from a sheet of flat metal of an appropriate thickness (e.g., a thickness that is at least partly based on the stresses to be absorbed by the cams).

The cable 110 may be made of various materials (e.g., braided steel “rope” cables) and/or be formed in different lengths, as appropriate. The specific dimensions of the cable may be based at least partly on various factors such as the diameter, weight, operating tension, and/or flange characteristics of the ducts being connected. In addition, the intended use of the ducts may at least partly influence the dimensions of the cables. The ducts and duct flanges may include various materials, types, etc.

The threaded ends 120 may be any appropriate diameter and/or pitch. The diameter of the threaded ends may depend on various factors such as the size of any available through-holes in the flanges of the ducts being connected, the diameter of a securing nut used to couple each threaded end to a flange, etc. The pitch may depend on the type or pitch of the securing nut, and/or other appropriate factors. The securing nut attached to the threaded joint may be a lock nut (i.e., a nut that resists loosening under vibration and/or torque). The threaded ends may be attached to the cable in various appropriate ways (and/or may be formed in conjunction with the cable). For instance, the threaded ends may be swaged or welded to the cable, may be attached using adhesive, etc.

The anti-rotation cams 130 may be V-shaped pieces of metal of appropriate thickness, height, and width. The cams may be coupled to the threaded end 120. The cams may be attached to the threaded ends in various appropriate ways (e.g., welding the cams to the threaded ends, using a nut, forming the cams and threaded ends as a single casting, using adhesive, etc.). The thickness, height, and/or width of the anti-rotation cams 130 may be at least partially based on various appropriate factors such as the diameter, size, and/or type of cables, the characteristics of the flanges, intended use, etc.

Although the anti-rotation cable restraints 100 have been described with reference to various specific features, one of ordinary skill in the art will recognize that the restraints may be configured in various different ways without departing from the spirit of the invention. For instance, although the restraints have been described as being formed of metal components, the restraints may also be made at least partly from various other appropriate materials (e.g., plastic, rubber, etc.) and in various appropriate ways (e.g., welded, bonded, formed, injection-molded, etc.). As another example, although the cams have been described as V-shaped, the cams may be made in various other appropriate shapes (e.g., oval, rectangular, etc.). The materials, manufacturing processes, and/or shapes used may depend on various appropriate factors associated with various particular applications.

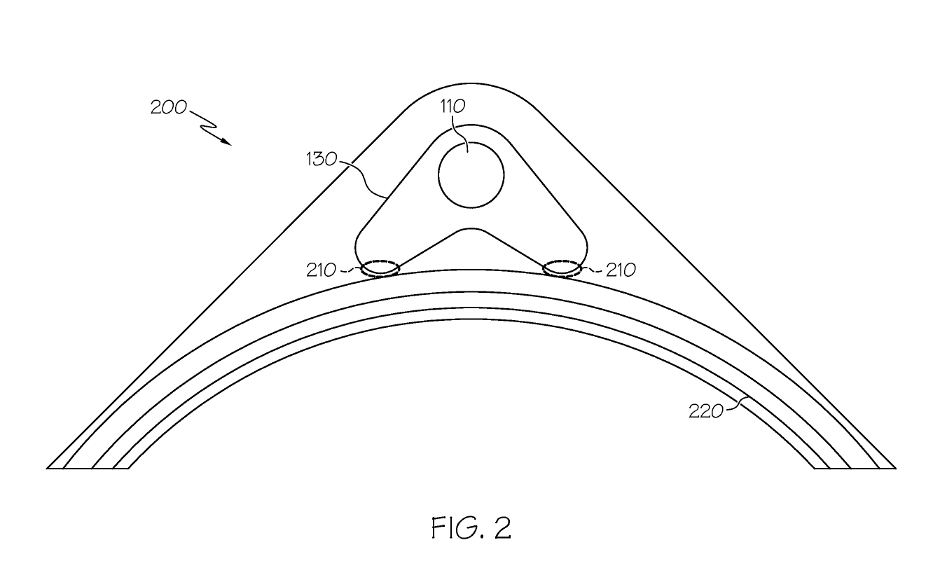

FIG. 2 illustrates a side view 200 of the cable restraint of FIG. 1, specifically showing the anti-rotation cam 130. As shown; the anti-rotation cam (which is V-shaped in this example) includes two contact sections 210 which each prevent the cam from rotation in a particular direction (i.e., a first contact section may prevent the cam from rotating in a clockwise direction while a second contact section may prevent the cam from rotating in a counter-clockwise direction, or vice-versa) when coming in contact with a portion of a surface of the duct flange 220. Because the cam is coupled to the fitting 120 at a through-hole in the body of the cam, the cable is also prevented from rotating. The V-shaped cam provides a way to prevent rotation in both a clockwise and counter-clockwise direction, depending on which contact section is impeded by the flange.

The anti-rotation cam 130 may be configured in various appropriate ways to match various flanges. For instance, the height or width of the “V” may be varied such that appropriate mounting clearance is provided by the cable restraint (i.e., the “V” may be sized such that the cable restraint allows some rotational movement without contacting the cable flange). In this manner, the restraint may be aligned with an associated attachment point on the flange (e.g., the position of the restraint may be varied as the threaded end of the restraint is positioned within a through-hole in the flange, without having the cam come in contact with the surface of the duct flange) in a way that allows some flexibility in the position of the cables as they are attached or detached. In addition, the edges of the contact sections may be shaped in various appropriate ways (e.g., rounded at various diameters, angular, etc.).

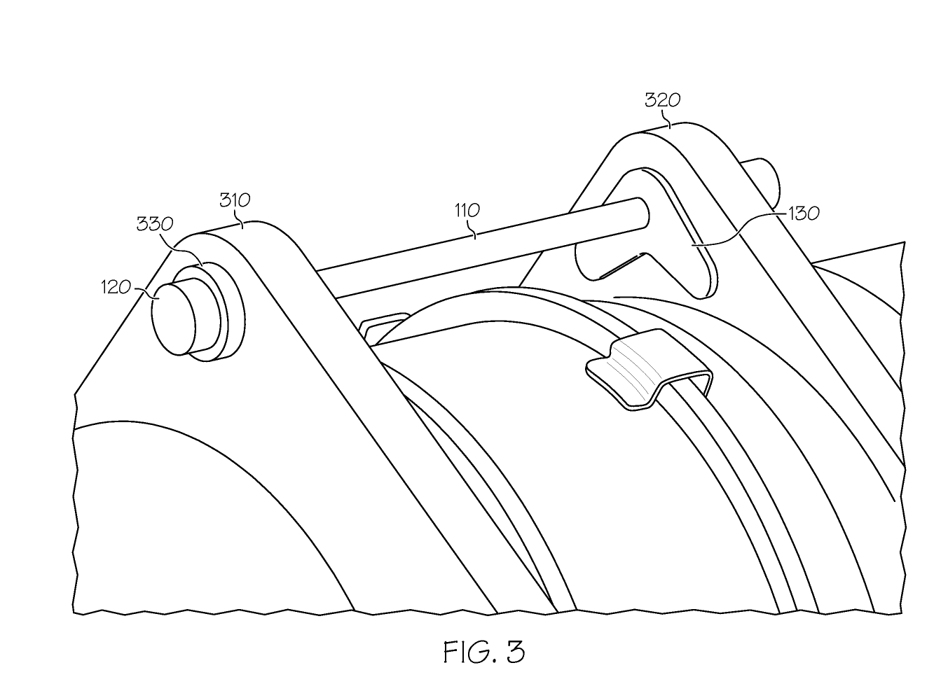

FIG. 3 illustrates a perspective view of the cable restraint 100 of FIG. 1 during use. As shown, the cable restraint is coupled at a first end to a duct flange 310 of a first duct and coupled at a second end from a duct flange 320 of a second duct. The cable restraint is secured to the duct flange in this example with a nut 330 placed on the exterior side of the duct flange.

Different numbers and/or types of cable restraints may be used to secure various duct segments depending on various factors. For instance, the number of cable restraints used to connect ducts at one location may vary depending on the size of the ducts, the operating conditions of the ducts, the loads placed on the ducts, etc. In addition, a single connection may include different restraints (e.g., restraints of different physical dimensions, different material compositions, etc.), which may vary depending on the size of the ducts, the operating conditions of the ducts, the types of ducts, etc.

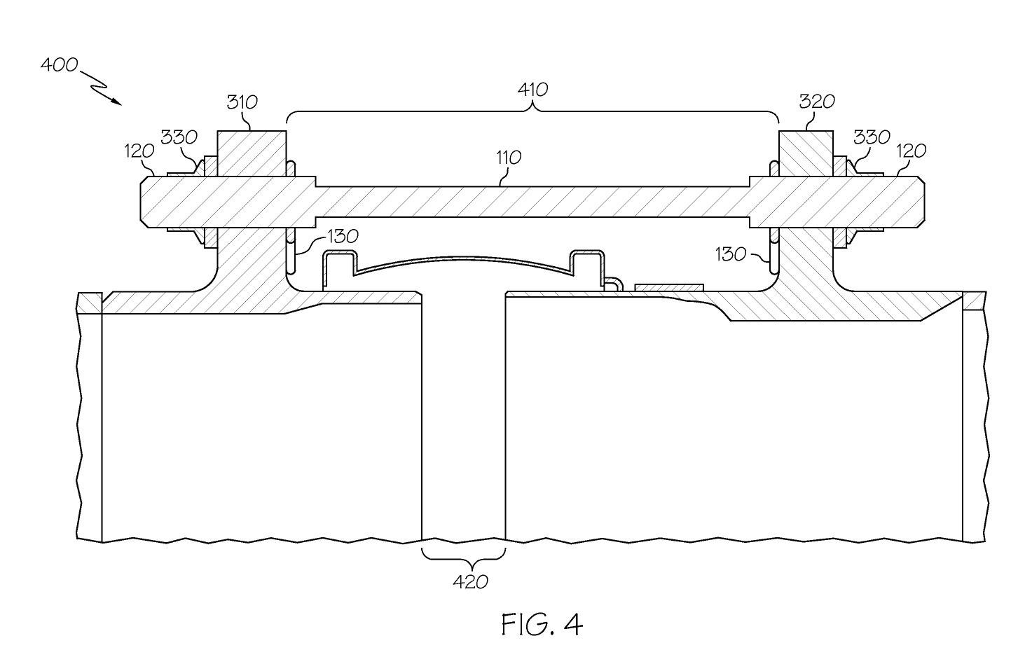

FIG. 4 illustrates a section view 400 of the cable restraint of FIG. 1 during use, specifically highlighting a gap 410 maintained by the cable restraint that corresponds to a desired (or “controlled”) gap 420 between the flanges. The desired gap may be at least partly based on various appropriate factors (e.g., the types of duct, the types of flanges, the operating conditions of the connected ducts, etc.). Different cable restraints may be adapted to maintain different desired gaps, as appropriate. The desired gap may be any appropriate distance (e.g., a distance specified by the duct manufacturer and/or the flange manufacturer, distances calculated by a system designer, etc.) for the ducts being connected.

As shown in FIG. 4, the anti-rotation cams 130, each being coupled to each of the outer threaded fittings 120, which are each coupled to the cable 110 in this example, do not allow linear movement of the duct flanges 310-320 along the cable 110 (or linear movement of the ducts corresponding to the flanges). In this manner, the anti-rotation restraint 100 maintains the desired gap 420 between the ducts by maintaining a corresponding gap 410 between the flanges of the ducts.

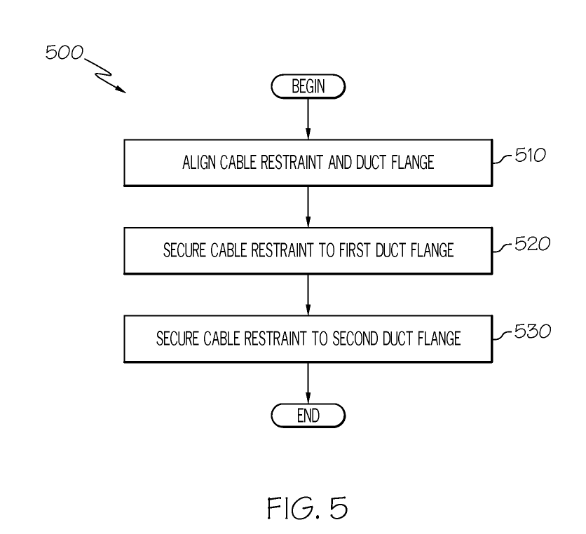

FIG. 5 illustrates a conceptual process 500 used in some possible embodiments when connecting or disconnecting a pair of ducts. Such ducts may include flanges 310-320 such as those described above in reference to FIG. 3. The process may begin when a pair of ducts is to be connected or disconnected. Next, when the ducts are to be disconnected, the cable restraint and duct flange may be aligned (at 510). When the ducts are to be disconnected, the restraint and duct will already be aligned, rendering such alignment unnecessary.

The process then secures (at 520) the cable restraint to a first duct flange. When the cables are to be disconnected, the cable restraint may instead be released from the first duct flange. As described above in reference to FIG. 2, when the cable restraint is secured or released, the anti-rotation cam may prevent the cable restraint from turning, allowing one-handed installation or removal of a securing nut coupled to a threaded end of the cable restraint.

Next, the process secures (at 530) the cable restraint to a second duct flange. When the cables are to be disconnected, the cable restraint may instead be released from the second duct flange. As above, when the cable restraint is secured or released, the anti-rotation cam prevents the cable restraint from turning, allowing one-handed installation or removal of a securing nut coupled to the other threaded end of the cable restraint.

Process 500 (or portions thereof) may be performed multiple times (e.g., when installing more than one cable restraint at a connection) and/or may be partially performed (e.g., when disconnecting the cable restraint(s) from one flange but not the other).

It should be understood, of course, that the foregoing relates to exemplary embodiments of the invention and that modifications may be made without departing from the spirit and scope of the invention as set forth in the following claims.

We claim:

1. An anti-rotation cam adapted to prevent rotation of a cable restraint, the anti-rotation cam comprising:
a body having a through-hole adapted to be coupled to a fitting of the cable restraint;
a first leg extending out from the body and adapted to prevent the cam from rotating in a clockwise direction; and
a second leg extending out from the body and adapted to prevent the cam from rotating in a counter-clockwise direction.

2. The anti-rotation cam of claim 1, wherein the first leg is adapted to contact a surface of a duct flange.

3. The anti-rotation cam of claim 2, wherein the second leg is adapted to contact the surface of the duct flange.

4. The anti-rotation cam of claim 1, wherein the length of the first leg is equal to the length of the second leg.

5. The anti-rotation cam of claim 1, wherein the anti-rotation cam is welded to the fitting.

6. The anti-rotation cam of claim 1, wherein the anti-rotation cam is swaged to the fitting.

7. The anti-rotation cam of claim 1, wherein the anti-rotation cam has rounded edges.

8. An anti-rotation cable restraint for connecting ducts, the cable restraint comprising:
a flexible cable;
a first threaded end coupled to the cable along an axis of the cable; and
a first anti-rotation cam coupled to the first threaded end perpendicular to the axis of the cable, the cam being adapted to prevent rotation of the cable and the first threaded end when a nut is secured to the first threaded end.

9. The anti-rotation cable restraint of claim 8, wherein the first anti-rotation cam is V-shaped.

10. The anti-rotation cable restraint of claim 8, wherein the nut is a lock nut.

11. The anti-rotation cable restraint of claim 8, wherein the first threaded end is adapted to be coupled to a duct flange of a flexible duct.

12. The anti-rotation cable restraint of claim 11, wherein the flexible cable comprises braided steel.

13. The anti-rotation cable restraint of claim 8, including:
a second threaded end coupled to the cable along the axis of the cable, wherein the second threaded end is adapted to be coupled to a duct flange of a flexible duct; and
a second anti-rotation cam coupled to the second threaded end perpendicular to the axis of the cable,
wherein the first and second anti-rotation cams are spaced along the cable such that a desired gap is maintained between the first and second duct flanges.

14. The anti-rotation cable restraint of claim 8, wherein the nut is able to be secured using a single tool.

15. A method of coupling a first flexible duct having a first flange to a second flexible duct having a second flange using an anti-rotation cable restraint, the method comprising:
aligning the cable restraint with a through-hole in the first flange;
securing the cable restraint to the first flange using a first lock nut;
aligning the cable restraint with a through-hole in the second flange; and
securing the cable restraint to the second flange using a second lock nut.

16. The method of claim 15, including setting an appropriate gap between the first and second flexible ducts using anti-rotation cams fixed along a length of the cable restraint such that the cams restrain the movement of the first and second flange along an axis parallel to the length of the cable restraint.

17. The method of claim 16, wherein the anti-rotation cams are V-shaped.

18. The method of claim 15, wherein the securing of the cable restraint to the first flange is performed using a single tool.

19. The method of claim 18, wherein the securing of the cable restraint to the second flange is performed using a single tool.

20. The method of claim 15,
wherein the first lock nut is secured to a first threaded end of the anti-rotation cable restraint, and
wherein the second lock nut is secured to a second threaded end of the anti-rotation cable restraint.
